(19) United States
(12) Patent Application Publication
(10) Pub. No.: US 2015/0217794 A1
(43) Pub. Date: Aug. 6, 2015

(54) Steering Wheel Cover

(71) Applicant: Bell Automotive Products, Inc., Scottsdale, AZ (US)

(72) Inventors: C. Kwai Kong, Gilroy, CA (US); Joleen M. Jansen, Omaha, NE (US); Yu He, Ningbo (CN); Ken Krankkala, Anthem, AZ (US)

(21) Appl. No.: 14/689,321

(22) Filed: Apr. 17, 2015

Related U.S. Application Data
(63) Continuation-in-part of application No. 14/072,621, filed on Nov. 5, 2013.
Application No. 14/072,621 is a continuation-in-part of application No. 13/623,211, filed on Sep. 20, 2012.
(60) Provisional application No. 61/980,892, filed on Apr. 17, 2014.

(30) Foreign Application Priority Data
Jun. 15, 2012 (CN) 201220296126.4

(51) Int. Cl. B62D 1/06; B29C 44/06

(52) U.S. Cl. CPC B62D 1/06; B29C 44/06; B29L 2031/3047

(57) ABSTRACT

A steering wheel cover comprising a core layer is disclosed. The core layer includes an inner surface molded to form and self-maintain an annular channel sized to receive an automobile steering wheel therein. The core layer also includes an outer surface and two opposing terminating edges. The steering wheel cover is devoid of an outer cover layer coupled to the core layer. Thus no adhesives or stitching are required. In particular embodiments, the core layer includes a first foamed material, such as but not limited to ethyl-vinyl acetate. The core layer may also include one or more protrusions extending from the outer surface of the core layer. The protrusions may include a second foamed material of a different hardness than the first foamed material. The core layer may also include ribs protruding from the inner surface of the annular channel and/or holes extending through the core layer.

### CROSS REFERENCE TO RELATED APPLICATIONS

This document claims the benefit of the filing date of U.S. Provisional Patent Application 61/980,892, entitled “Steering Wheel Cover” to Kong, which was filed on Apr. 17, 2014, the contents of which are hereby incorporated by reference.

This application is also a continuation-in-part application of the earlier U.S. Utility patent application to He et al. entitled “Steering Wheel Cover,” application Ser. No. 14/072,621, filed Nov. 5, 2013, now pending, which application is a continuation-in-part application of the earlier U.S. Utility patent application to He entitled “Steering Wheel Cover,” application Ser. No. 13/623,211 filed Sep. 20, 2012, which claims priority to the foreign Chinese Application No. 201220296126.4, filed May 3, 2012, and issued on Aug. 7, 2013 as CN 203111288, the disclosures of all of which are hereby incorporated herein by reference.

### BACKGROUND

1. Technical Field

Aspects of this document relate generally to steering wheel covers.

2. Background Art

Many drivers use steering wheel covers to enhance their driving experience. Many steering wheel covers, however, do not have the flexibility requirements sufficient to satisfy two components of utilization: flexible enough for easy installation of the steering wheel cover on a steering wheel and simultaneously strong enough to remain on the steering wheel once installed. Many steering wheel covers also often carry a very foul odor from the materials of the steering wheel cover, odors that subsequently permeate a foul smell throughout the vehicle. Steering wheel covers are also known to damage the steering wheel itself by transferring color from the core layer of the steering wheel cover to the steering wheel and/or otherwise marking or scratching the steering wheel.

### SUMMARY

According to a first aspect, a steering wheel cover consists essentially of a core layer, the core layer comprising an inner surface molded to form and self-maintain an annular channel sized to receive an automobile steering wheel therein, an outer surface, and two opposing terminating edges.

One or more embodiments may comprise one or more of the following. The core layer may comprise a first foamed material. The first foamed material may comprise ethyl-vinyl acetate. The core layer may further comprise a plurality of ribs protruding from the inner surface of the annular channel. The core layer further may comprise one or more protrusion extending outward from the outer surface of core layer. The one or more protrusions may comprise a second foamed material that is firmer than the first foamed material. The first foamed material may be molded to the second foamed material. A plurality of holes extending through the core layer.

According to another aspect, a steering wheel cover may comprise a core layer, the core layer comprising an inner surface molded to form and self-maintain an annular channel sized to receive an automobile steering wheel therein, an outer surface, and two opposing terminating edges, wherein the steering wheel cover is devoid of an outer cover layer coupled to the core layer and stitching proximate the two terminating edges.

Particular embodiments may comprise one or more of the following. The core layer may comprise a first foamed material. One or more protrusions extending from the outer surface of the core layer. The protrusions may comprise a second foamed material molded to the first foamed material. The first and second foamed materials may comprise different densities. A plurality of ribs protruding from the inner surface of the annular channel. A plurality of holes extending through the core layer. The first foamed material may comprise primarily ethyl-vinyl acetate.

According to yet another aspect, a method of manufacturing a steering wheel cover, the method may comprise injecting a first foamed material into a first cavity of a mold assembly to form a core layer of a steering wheel cover, curing the core layer, removing the core layer from the mold assembly, and cooling the core layer such that the core layer comprises a self-maintaining annular channel sized to receive an automobile steering wheel therein.

Particular embodiments may comprise one or more of the following. Injecting a second foamed material into a one or more second cavities of the mold assembly adjacent the first cavity to form one or more protrusions extending from an outer surface of the core layer, wherein curing the core layer comprises curing and bonding together the core layer and the one or more protrusions. The first foamed material and the second foamed material may comprise different densities. Forming one or more holes in the core layer during molding.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The invention will hereinafter be described in conjunction with the appended drawings, where like designations denote like elements, and:

FIG. 1 is a perspective view of a first embodiment of a steering wheel cover;

FIG. 2 is a cross sectional view of the steering wheel cover of FIG. 1;

FIG. 3 is a front view of a second embodiment of a steering wheel cover;

FIG. 4 is a front view of a third embodiment of a steering wheel cover;

FIG. 5 is a front view of a fourth embodiment of a steering wheel cover;

FIG. 6 is a front view of a fifth embodiment of a steering wheel cover; and

FIG. 7 is a cross sectional view taken along line B-B of FIG. 3.

### DESCRIPTION

This disclosure, its aspects and implementations, are not limited to the specific components or assembly procedures disclosed herein. Many additional components and assembly procedures known in the art consistent with the intended steering wheel cover and/or assembly procedures for a steering wheel cover will become apparent for use with implementations of steering wheel covers from this disclosure. Accordingly, for example, although particular steering wheel covers are disclosed, such steering wheel covers and implementing components may comprise any shape, size, style, type, model, version, measurement, concentration, material, quantity, and/or the like as is known in the art for such steering wheel covers and implementing components, consistent with the intended operation of manufacturing a steering wheel cover.

Conventional steering wheel covers often carry a foul odor, are difficult to install onto a steering wheel due to their poor flexibility, and are undesirably mark the steering wheel. As shall be described in greater detail throughout this document, one or more embodiments of a steering wheel cover contemplated herein comprise an core layer having a composition that is flexible enough to allow a user to easily install the steering wheel cover onto a steering wheel while simultaneously being strong enough to hold the steering wheel cover in place on the steering wheel and self-maintain the shape of the core layer. Due to the improved composition of the core layer, embodiments of the steering wheel cover contemplated herein also do not leave a foul odor in the vehicle.

In contrast to conventional steering wheel covers, one or more embodiments of a steering wheel cover contemplated in this disclosure comprise only a core layer and do not require an outer cover layer coupled to the core layer. Because steering wheel covers contemplated herein do not require an outer cover layer, the steering wheel covers also do not require stitching proximate the terminating edges of the core layer. Conventional steering wheel covers typically require stitching proximate the terminating edges of the core layer, which stitching helps to curl the terminating edges outward away from the center of the core layer or the opposing terminating edge of the core layer. Elimination of the stitching and the outer cover layer also improves the overall flexibility of the steering wheel cover. As a result, embodiments of the steering wheel cover disclosed herein comprising a core layer and no outer cover layer typically comprise uniform stretchability. This stretchability of the steering wheel cover allows the steering wheel cover to fit comfortably on more than one size of steering wheel.

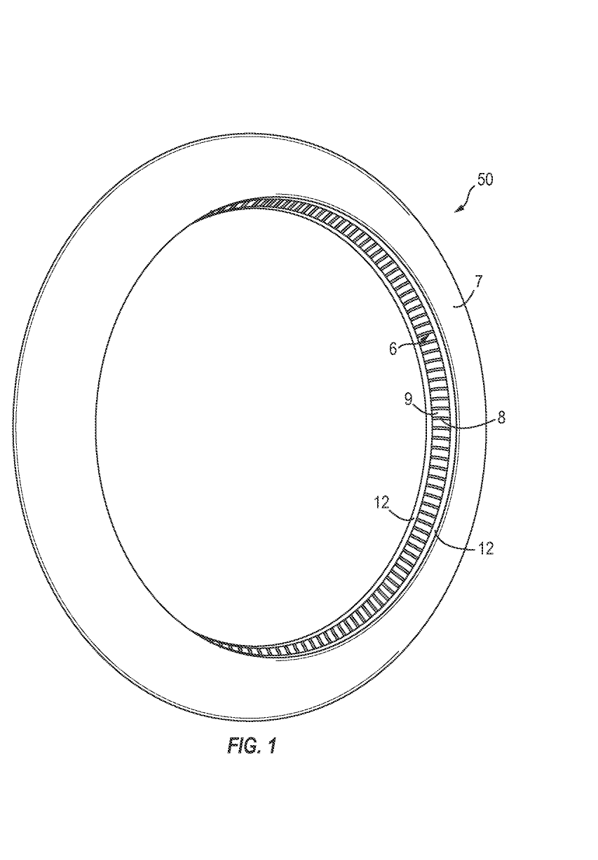

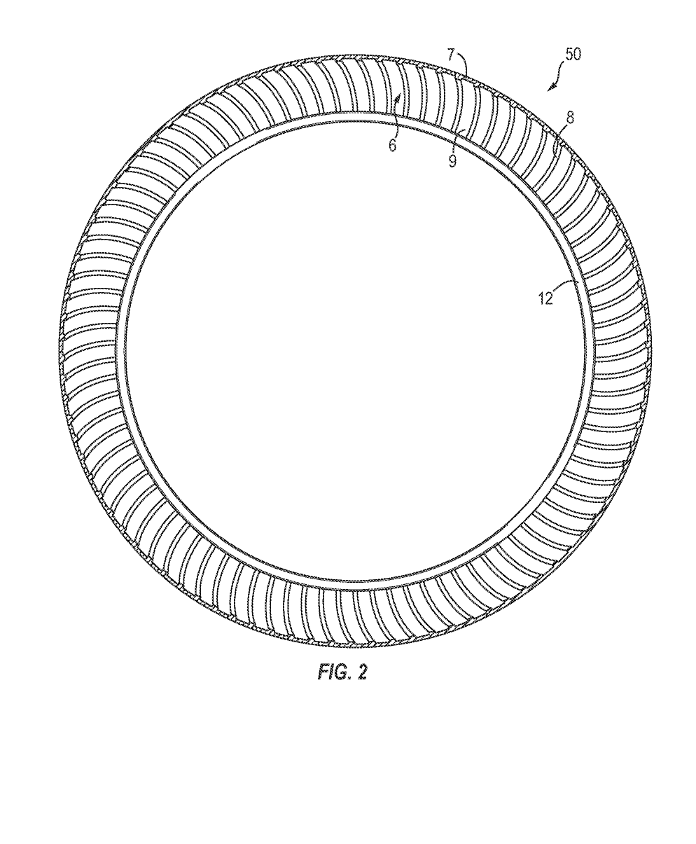

FIG. 1 depicts a perspective view and FIG. 2 depicts cross sectional view of a non-limiting embodiment of a steering wheel cover. As with other contemplated embodiments in this disclosure, the steering wheel cover in FIGS. 1 and 2 comprises a core layer 50 and is devoid of an outer layer and any stitching. More specifically, the core layer 50 comprises two terminating edges 12, an outer surface 7, and an inner surface 9 shaped to form and self-maintain an annular channel 6 sized to receive an automobile steering wheel therein, and one or more ribs 8. Another advantage of elimination of stitching on the terminating edges 12 of the core layer 50 is that the core layer 50 comprises little or no gap between terminating edges 12 of the core layer 50 when the core layer is in its natural state not coupled to a steering wheel. Some embodiments of the core layer 50 comprise a composition described in greater detail below that allows the core layer 50 to maintain its curved shape without any other support bodies or couplings. According to some aspects, the core layer 50 comprises a foamed material. The foamed material may comprise but is not limited to rubber, polyurethane, polyvinyl chloride (PVC), ethyl-vinyl acetate (EVA), silicone, and/or any combination thereof. The process for foaming materials is known in the art or may be determined by one of ordinary skill in the art from this disclosure.

More specifically, in some embodiments the core layer 50 comprises primarily EVA and is configured to maintain an inner surface 9 shaped to form an annular channel 6. In one or more embodiments, the core layer 50 comprises primarily EVA and at least one of a hardening agent and a flexibility agent that together form a flexible material that maintains its shape. Maintaining its shape means that the core layer 50 maintains the shape it was molded to without requiring additional external support until external physical force is applied to the core to deform the shape. Gravity acting alone on the core is not enough to deform its shape. The inclusion of the hardening agent in the primarily EVA material used to form the core layer 50 enables the core to self-maintain its molded shape.

One or more embodiments of a steering wheel cover further comprise a core layer 50 comprising a plurality of ribs 8 protruding from an inner surface 9 of the core layer 50. The plurality of ribs 8 may be arranged in any of a variety of directions, such as but not limited to latitudinal ribs, longitudinal ribs and/or angled ribs directed at any angles. The plurality of ribs 8 are each, in certain embodiments, spaced an equal distance apart from one another, though equal spacing is not required in all embodiments. In particular embodiments, the ribs 8 are spaced less than approximately one inch from one another. In more particular embodiments, the ribs 8 are spaced less than approximately ½ of an inch from one another. In more particular embodiments, the ribs 8 are spaced about ¼ of an inch from one another.

The plurality of ribs 8 may also be, in particular embodiments, formed to protrude a substantially equal distance from the inner surface 9 of the core layer. Formation of the ribs 8 will be described in greater detail elsewhere in this document. In some embodiments, each of the plurality of ribs 8 protrudes between approximately 1/64 of an inch and approximately ¼ of an inch from the inner surface 9, or less than ¼inch. In more particular embodiments, each of the plurality of ribs 8 protrudes between about 1/16 and 1/32 of an inch from the inner surface 9.

Each of the plurality of ribs 8 may also taper from the center of the rib 8 towards the terminating edges 12 of the core layer 50 in some embodiments. This rib 8 tapering feature allows for maximum fraction to prevent slipping of the core layer 50 on the steering wheel, thus increasing friction between the core layer 50 and the steering wheel in an axial form to increase the coefficient of friction. Additionally, in such embodiments the steering wheel cover is less bulky where the terminating edges 12 of the of the core layer 50 are positioned on the steering wheel, thus allowing for a better fit and easier gripping by the driver.

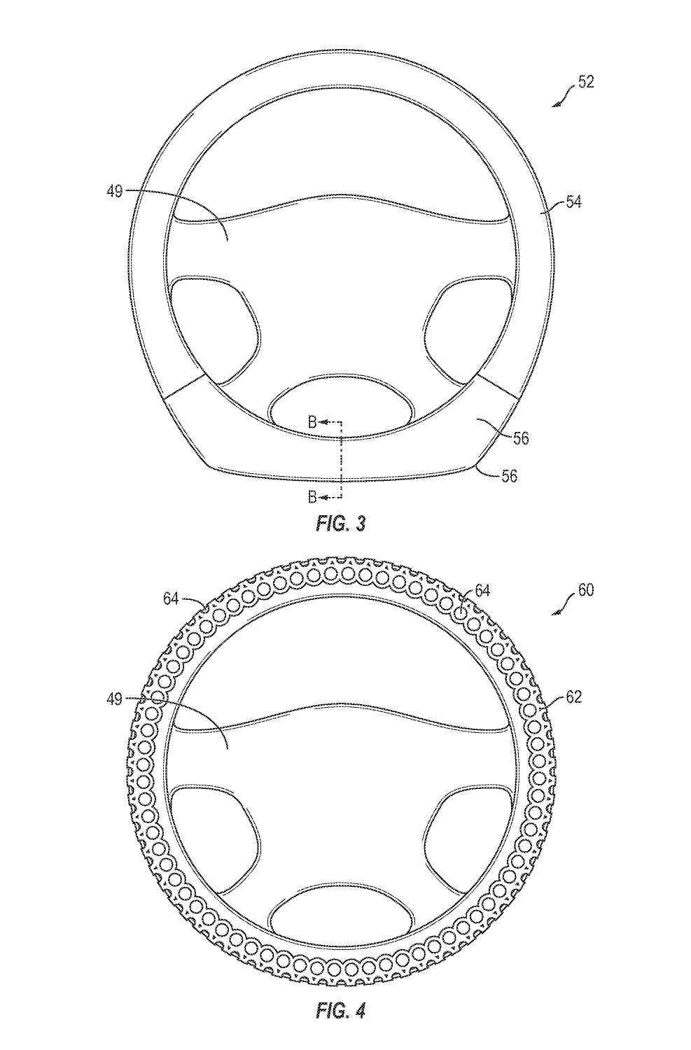

In some embodiments, such as that depicted in FIGS. 1 and 2, the outer surface 7 of the core layer 50 may be substantially smooth. In other embodiments, the outer surface of the core layer comprises one or more protrusions that improve the grip or overall look of the steering wheel cover. FIGS. 3-6 depict other non-limiting embodiments of steering wheel covers comprising a core layer with protrusions and/or holes while also devoid of any outer layer of any other material coupled to the outer surface of the core layer. As shall be described in greater detail, these protrusions may be molded as part of the core layer during original molding of the core layer. The protrusions may also be formed through a cross-linking process, resulting in the protruding portion having a density that is different than the density of the core layer. According to some aspects, the protrusions on the contemplated core layer comprise a single or continuous integral body after the molding process, even if the materials of the protrusions comprise different densities or compositions than the material of the rest of the core layer. According to some aspects, the protrusions comprise a compatible material to the core layer formed through cross-linking with the core layer. More particularly, in some embodiments, the protrusions are co-molded and/or cured and bonded together with the core layer. As with other embodiments described herein, the steering wheel embodiments depicted in FIGS. 3-7 may comprise a core layer having a self-maintaining annular channel.

FIG. 3 depicts a non-limiting embodiment of a steering wheel cover having a core layer 52 with a protrusion 56 molded to form a substantially flattened bottom portion. The substantially flattened bottom portion typically comprises two rounded corners 58. In the particular non-limiting embodiment depicted in FIG. 3, the protrusion 56 extends continuously for approximately ⅓ of the circumference of the steering wheel covered and would typically be positioned on the base of the steering wheel 49, though other embodiments may place the protrusion at other positions on the steering wheel cover. In other embodiments, the protrusion 58 extends more or less than ⅓ of the circumference of the steering wheel cover and/or comprises breaks or gaps.

Like other embodiments contemplated herein, in the non-limiting embodiment depicted in FIG. 3, the steering wheel cover comprises only a core layer 52 devoid of an outer cover layer of other non-compatible material coupled thereto or any stitching. According to some aspects, the protrusion 56 may be co-molded and/or cross-linked over the core layer 52. According to other aspects, the protrusion 56 is co-molded or cross-linked between two ends of the main core layer 52. The protrusion 56 and rounded corners 58 may comprise a density that is equal, greater, or less than the density of the remainder of the core layer depending upon the particular needs for the design involving the protrusion 56. In one non-limiting embodiment, the flattened protrusion 56 and/or rounded corners 58 comprises a material compatible for cross-linking with the core layer that is more dense, or firmer, than the remainder of the core layer.

FIG. 7 depicts a cross-sectional view of the steering wheel cover of FIG. 3 taken along line B-B. As depicted, the core layer 52 comprises two terminating edges 55, and inner surface 53, and outer surface 54, and a self-maintaining annular channel 6. In this particular embodiment, the core layer 52 is devoid of ribs 8, but other embodiments of a core layer 52 may comprise ribs 8 as previously described.

As further depicted in the cross-sectional view of FIG. 7, the core layer 52 comprises a protrusion 56 extending from the outer surface 54 of the of the core layer 52. According to some aspects, the core layer 52 comprises a first foamed material and the protrusion 56 comprises a second foamed material having a different density or firmness than the rest of the core layer 52. More particularly, the second foamed material of the protrusion 56 may comprise a density that is less than the density of the first foamed material of the rest of the core layer 52. In other embodiments, the second foamed material of the protrusion may comprise a density that is more than the density of the first foamed material of the rest of the core layer 52. While the foamed materials of the protrusion 56 and the rest of the core layer 52 comprise different densities and are depicted with a dividing line between the two in the cross-sectional view of FIG. 7, it is contemplated that the protrusion 56 may be a singular continuous body integral with the rest of the core layer 52. Thus, the protrusion 56 may not constitute an outer cover layer as is commonly done in the art because no adhesives, stitching or other couplings are required to couple protrusion 56 to the rest of the core layer 52. Instead, the protrusion 52 is molded to the core layer 52 during manufacture. As mentioned before, adhesives, stitching, and other couplings formed of non-compatible material that does not cross-link with the core material (in many embodiments, non-foamed material), restricts stretchability of the final steering wheel cover product to too great a degree, and thus is undesirable.

The embodiment of FIG. 3 is presented for exemplary purposes only and not by way of limitation. It is also contemplated that the protrusions of other embodiments may be formed as one or more latitudinal ribs, rounded nubs, oval or polygonal shaped protrusions at approximately 10 and 2 o'clock, as is commonly referenced in the driving industry, on the steering wheel cover, and so on. Although not shown in the embodiments of FIGS. 1-7, various embodiments of a steering wheel cover contemplated herein may comprise a raised parting line. The raised parting line is typically formed during molding and is generally placed approximately central between the two terminating edges of the core layer. In conventional steering wheel designs that include a core formed through a molding process, the parting line placement is not critical because it is covered by other materials in the final steering wheel product. However, in embodiments of the present disclosure, additional other materials do not cover the core molded material, so placement of the parting line is more aesthetically important. In many embodiments, the parting line may be incorporated into the aesthetic design of the steering wheel cover.

FIG. 4 depicts another non-limiting embodiment of a steering wheel cover. In this and other non-limiting embodiments, the steering wheel cover comprises a core layer 60 having a outer surface 62, an annular channel configured to hold therein a steering wheel 49, and one or more holes 64 or other openings extending through the core layer 60. While the embodiment depicted in FIG. 4 does not include any protrusions extending from the outer surface 62 of the core layer 60, it is contemplated that such a configuration may include any of the protrusions described elsewhere in this document. Similarly, the holes similar to the holes 64 depicted in the core layer 60 depicted in FIG. 4 maybe applied to other core layers described herein.

Another advantage of having a core layer 60 without an outer cover layer of a non-compatible/non-cross-linkable material is the option to provide a steering wheel cover that improves the grip of the steering wheel cover without adding a significant amount of bulk to the steering wheel. Some users may prefer to add addition ridges or texture to their steering wheel without adding significant bulk and/or while still allowing the user to touch or feel the original steering wheel. The non-limiting embodiment of a steering wheel cover shown in FIG. 4 solves this problem. While the holes 64 of the core layer 60 in FIG. 4 are substantially circular, in other embodiments the openings may be shaped as longitudinal or latitudinal openings extending through the core layer 60. The plurality of holes 64 or other openings are typically formed into core layer 60 during manufacture or molding of the core layer 60. These holes 64 or other openings may improve grip on the steering wheel and/or add to the overall appearance of the steering wheel without adding significant bulk to the size of the steering wheel. The holes 64 or other openings may be formed proximate terminating edges of the core layer and/or the central portion of the core layer between opposing terminating edges. Using a molded, foamed material such as foamed EVA allows the steering wheel cover to be molded into a wide variety of shapes, styles and designs at very low cost.

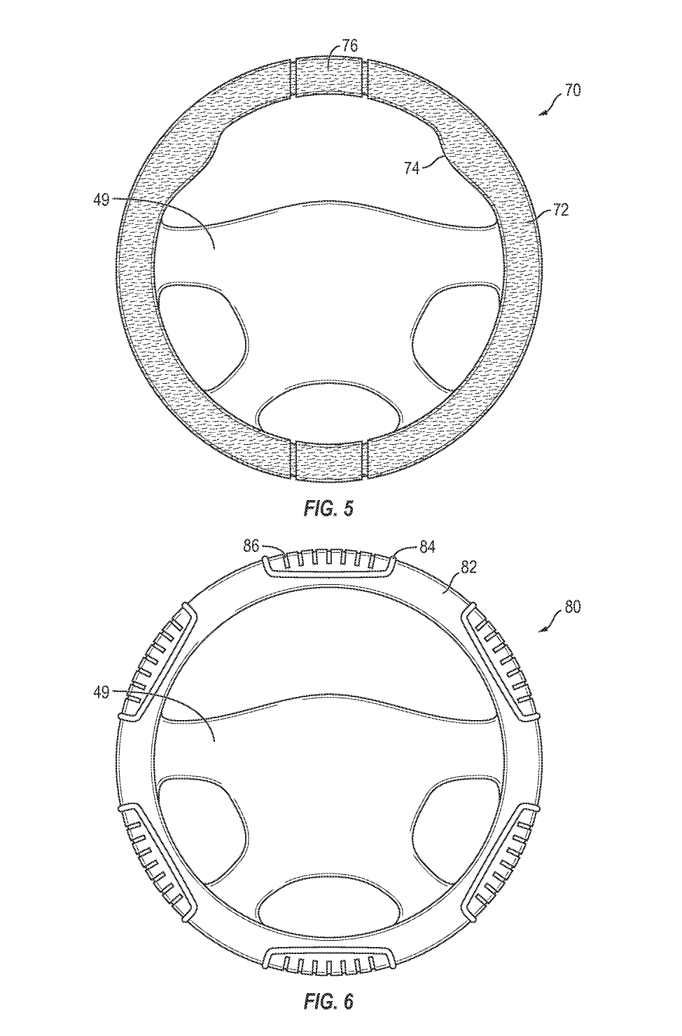

FIG. 5 depicts another non-limiting embodiment of a steering wheel cover having a core layer 70 and devoid of an outer cover layer of non-cross-linking material. In one or more embodiments, a core layer 75 may comprise sections or portions of differing colors. For example, in the embodiment depicted in FIG. 5, the center sections 76 comprise a different color than the side sections 77. This configuration is accomplished during the molding process of manufacturing. According to some aspects, a channel separates the center sections 76 from the side sections 77. The center sections 76 and side sections 77 may comprise equal or different densities, as described in greater detail in this document in relation to other embodiments.

The non-limiting embodiment depicted in FIG. 5 further comprises two gripping protrusions 74 on the outer surface 72. The two protrusions 74 are positioned to provide improved comfort and grip for the drivers, typically at a 10 o'clock and 2 o'clock position. The protrusions may be of equal or different densities than the rest of the core layer 70. According to some aspects, both the center sections 76 and the side sections 77 are formed as protrusions on the core layer 70, with the specific gripping protrusions 74 at 10 o'clock and 2 o'clock extending further outward than the rest of the side section 77. In still other embodiments, gripping protrusions 74 similar to those shown in FIG. 5 may be positioned anywhere on the steering wheel cover. Like other embodiments contemplated herein, the protrusions contemplated in FIG. 5 are formed integrally with the core layer during molding, and do not require any stitching or adhesives to couple together.

In one or more embodiments, a core layer 70 may comprises a textured outer surface 72. For example, in the non-limiting embodiment depicted in FIG. 5, the outer surface 72 comprises a leather-like textured outer surface 72. Other embodiments contemplated herein may include similarly textured surfaces without departing from the scope of this disclosure.

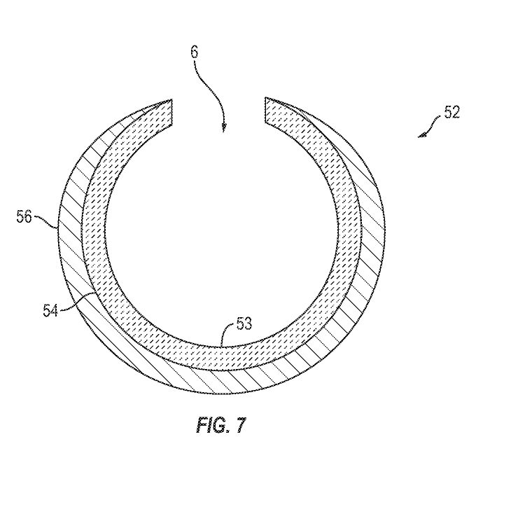

FIG. 6 depicts another non-limiting embodiment of a steering wheel cover having a core layer 80 and devoid of an outer cover layer. In one or more embodiments, a core layer 80 comprises one or more gripping areas 87. The gripping areas 87 may comprise protrusions, slots, recessing, or any combination thereof. The protrusions, slots, recessing, and the like are typically formed during molding and do not require adhesives or stitching. In the non-limiting embodiment of FIG. 6, each gripping area 87 comprises a protruding boundary 84 extending from the outer surface 82 of the core layer 80. Within the area of each protruding boundary 84 are a plurality of slots 86. The slots 86 may extend all the way through the core layer 80 to partially expose the steering wheel or, alternatively, may extending only partially into the core layer 80. In other embodiments, protrusions may replace the slots 86, and a channel may replace the protruding boundary 84. As with other embodiments, any protrusions may comprise equal or different densities of foamed material than the rest of the core layer 80.

Manufacture

As previously noted, various embodiments of core layers contemplated herein comprise a foamed material. The foamed material may comprise but is not limited to rubber, polyurethane, polyvinyl chloride (PVC), ethyl-vinyl acetate (EVA), silicone, and/or any combination thereof. According to some aspects, a core layer and/or any protrusions or secondary layers comprise cross-linked foam, which does not require the addition of adhesive or stitching. As described in greater detail below, in some embodiments, the composition of the core layer comprises a cross-linking agent that forms cross-links. In these or other embodiments, cross-linked foam may be formed by chemical reactions initiated by heat, pressure, pH, radiation, and the like.

In one or more embodiments a method of manufacturing a steering wheel cover comprises forming a steering wheel cover material by combining one or more raw materials. The raw materials comprise at least EVA, one or more of the hardening agents, and one or more of the first flexibility agents. In one or more embodiments, the raw materials further comprise one or more of the following: a de-molding agent, a second flexibility agent, a flowing agent, one or more emollients, an oxidizing agent, a cross-linking agent, a coloring agent, a foaming agent, and/or a curing agent. The amounts of raw materials used in forming the steering wheel cover material may be as described elsewhere in this document.

Combining the raw materials comprises, in one or more embodiments, mixing them together before being pelletized by any machine known in the art. More particularly, mixing the raw materials comprises adding the raw materials into an automatic feeding machine according to one aspect, sometimes in granular EVA form. The automatic delivery machine may be preset to a desired rate of delivery. The raw materials are typically extruded with an extruder, such as but not limited to a double screw extruder. The automatic delivery machine may be configured to perform one or more of the following during production of the core layer: melting, conveying, kneading, mixing, and extruding.

As noted above, an embodiment of a method may further comprise molding the steering wheel cover material to form a core layer comprising a self-maintaining annular channel sized to receive an automobile steering wheel therein. The molding may comprise injection molding or any other molding known in the art. According to some aspects, the molding comprises any multi-component molding known in the art, such as but not limited to co-molding or co-injection molding. According to other aspects, the molding comprises sandwich molding, bi-injection molding, and/or interval molding. Use of one or more of these molding mechanisms allows a manufacturer to form a core layer having various protrusions on the inner surface or outer surface that comprise a different density and/or color than the main body of the core layer. For example, in some non-limiting embodiments, the core layer may be formed through multi-component molding such that the protrusion comprise a density that is more or less than the density of the rest of core layer. In these and other embodiments, the materials used in the composition of the core layer and any protrusions, if present, are typically compatible materials that, in some certain aspects, allow cross-linking.

According to some aspects, a method of form a core layer comprises injecting a first material into a first cavity of a mold assembly to form a portion of a core layer and injecting at least a second material into a second cavity of a mold assembly to form a protrusion on either then inner surface or the outer surface of the core layer. Other embodiments may include injecting a third, fourth, fifth, and so material in respective cavities of the mold assembly to form any of the protrusions and/or ribs contemplated and described elsewhere in this disclosures. The first and at least second materials are cured and bonded together to form a steering wheel cover having an integrally formed, single bodied core layer devoid of any outer cover layer. More particularly, after the at least second material is injected, the mold assembly may be subjected to heat and pressure for a desired time to allow the first and the at least second materials to bond together. The core layer is then removed from the mold assembly and may be allowed expand, heat, and/or cool as desired. According to some aspects, one or more holes, openings, or slots that extend partially or entirely through the core layer may be formed during molding of the core layer. Such holes, openings, slots, and the like may be formed using aluminum or wood lasts, or any other instruments otherwise known in the art for molding of foamed materials.

Composition

Also contemplated in this disclosure is a core layer comprising a composition that comprises an improved flexibility and fewer or no foul odors when compared to conventional steering wheel covers. In particular, the modulus of elasticity of the core layer is low relative to conventional steer wheel covers, resulting in a greater flexibility of the steering wheel cover. In one or embodiments, the hardness of the core layer is between approximately 55 and 75 degrees on the A scale. In a more particular aspect, the hardness of the core layer is between approximately 60 and 70 degrees. In alternative embodiments, the hardness of the core layer is less than 55 degrees.

Also absent from one or more embodiments of the core layer composition is a color dye, thus inhibiting or otherwise preventing color migration from the steering wheel cover to a steering wheel. In particular embodiments, the inner surface of the core layer may be devoid of color dye, and other cross-linked layers may include color dye. Embodiments of the core layer disclosed herein also provide improved shock absorption and cushioning to the driver.

According to some aspects, the core layer comprises a foamed material. The foamed material may comprise but is not limited to rubber, polyurethane, polyvinyl chloride (PVC), ethyl-vinyl acetate (EVA), silicone, and/or any combination thereof. In one or more embodiments, the composition of the inner layer comprises a combination of at least ethylene-vinyl acetate (EVA) and a hardening agent. According to one aspect, the amount of EVA in the composition of the core layer comprises at least approximately 50 wt %. In another aspect, the composition of the core layer comprises about 60 wt % to about 80 wt % EVA. In still another aspect, the composition of the core layer comprises about 62 wt % to about 72 wt % EVA. In still a more particular aspect, the composition of the core layer comprises about 66 wt % to about 69 wt % EVA. In still a more particular aspect, the composition of the core layer comprises approximately 67.5 wt % EVA.

The hardening agent in the composition of the core layer may comprise any hardening agent previously known in the art. The one or more hardening agents allow the steering wheel cover to maintain its substantially circular shape, even after flexing to fit on the steering wheel. The one or more hardening agents are also in a quantity sufficient to allow the core layer to self-maintain its annular shape, including the annular channel. In one or more embodiments, the hardening agent comprises one or more thermoplastic polymers. The one or more thermoplastic polymers comprise at least one of the following: acrylic, nylon, polyethylene, polypropylene, polystyrene, and/or polyvinyl chloride. According to one aspect, the amount of hardening agent in the composition of the core layer comprises at least 2 wt %. In another aspect, the composition of the core comprises about 1 wt % to about 8 wt % hardening agent. In still another aspect, the composition of the core layer comprises about 2 wt % to about 6 wt % hardening agent. In still a more particular aspect, the composition of the core layer comprises about 3 wt % to about 5 wt % hardening agent. In still a more particular aspect, the composition of the core layer comprises approximately 4 wt % hardening agent.

In one or more embodiments, the composition of the core layer further comprises one or more first flexibility agents. The one or more first flexibility agents may comprise any flexibility agent configured to maintain the high flexibility of the core layer. In a particular embodiment, the one or more first flexibility agents comprise one or more elastomers. In more particular embodiments, the one or more first flexibility agents comprise one or more polyolefin elastomers. The one or more polyolefin elastomers comprise one or more of the following: polyisobutylene, ethylene propylene rubber, and/or ethylene propylene diene monomer rubber. According to one aspect, the amount of first flexibility agent in the composition of the core layer comprises at least approximately 7 wt %. In another aspect, the composition of the core layer comprises about 6 wt % to about 20 wt % first flexibility agent. In still another aspect, the composition of the core layer comprises about 6 wt % to about 16 wt % first flexibility agent. In still a more particular aspect, the composition of the core layer comprises about 9 wt % to about 14 wt % first flexibility agent. In still a more particular aspect, the composition of the core layer comprises approximately 11.5 wt % first flexibility agent.

In one or more embodiments, the composition of the core layer further comprises one or de-molding agents that help prevent the core layer from sticking in the mold during formation of the core layer. The de-molding agent may comprise talcum powder, ground calcium carbonate, or any other de-molding agents known in the art. According to one aspect, the amount of de-molding agent in the composition of the core layer comprises about 0 wt % to about 20 wt % de-molding agent. In still another aspect, the composition of the core layer comprises about 5 wt % to about 16 wt % de-molding agent. In still a more particular aspect, the composition of the core layer comprises about 9 wt % to about 13 wt % de-molding agent. In still a more particular aspect, the composition of the core layer comprises approximately 11 wt % de-molding agent.

In one or more embodiments, the composition of the core layer further comprises one or more second flexibility agents. The second flexibility agent may comprise fiber cloth, an EVA material, or any other flexibility agent known in the art. According to one aspect, the amount of second flexibility agent in the composition of the core layer comprises about 0 wt % to about 5 wt % second flexibility agent. In still another aspect, the composition of the core layer comprises about 0.25 wt % to about 2 wt % second flexibility agent. In still a more particular aspect, the composition of the core layer comprises about 0.5 wt % to about 1.5 wt % second flexibility agent. In still a more particular aspect, the composition of the core layer comprises approximately 0.96 wt % second flexibility agent.

In one or more embodiment, the composition of the core layer further comprises one or more flowing agents. The flowing agent may comprise paraffin or any other flowing agent previously known in the art that decreases the feeding time and/or increases the feeding speed during production. According to one aspect, the amount of flowing agent in the composition of the core layer comprises about 0 wt % to about 5 wt % flowing agent. In still another aspect, the composition of the core layer comprises about 0.5 wt % to about 3 wt % flowing agent. In still a more particular aspect, the composition of the core layer comprises about 1 wt % to about 2 wt % flowing agent. In still a more particular aspect, the composition of the core layer comprises approximately 1.66 wt % flowing agent.

In one or more embodiments, the composition of the core layer further comprises one or more emollients. In a particular embodiment, the emollients comprise one or more of the following: stearic acid and/or zinc stearate or any other compound or composition known in the art that reduces the stickiness of the core layer during production. In particular embodiments, the emollient is a non-toxic emollient derived from, for example, palm oil. According to one aspect, the amount of emollients in the composition of the core layer comprises about 0 wt % to about 5 wt % emollients. In still another aspect, the composition of the core layer comprises about 0.1 wt % to about 3 wt % emollients. In still a more particular aspect, the composition of the core layer comprises about 0.1 wt % to about 1 wt % emollients. In still a more particular aspect, the composition of the core layer comprises approximately 0.57 wt % emollients. Moreover, according to one aspect, the composition of the core layer comprises about 0.1 wt % to about 1.0 wt % stearic acid and about 0.05 wt % to about 0.5 wt % zinc stearate. In another aspect, the composition of the core layer comprises about 0.3 wt % to about 0.5 wt % stearic acid and about 0.1 wt % to about 0.2 wt % zinc stearate. In still another aspect, the composition of the core layer comprises about 0.41 wt % stearic acid and about 0.16 wt % zinc stearate.

In one or more embodiments, the composition of the core layer further comprises one or more oxidizers. In a particular embodiment, the oxidizer comprises zinc oxide. According to one aspect, the amount of oxidizers in the composition of the core layer comprises about 0 wt % to about 2 wt % oxidizers. In still another aspect, the composition of the core layer comprises about 0.5 wt % to about 2.5 wt % oxidizers. In still a more particular aspect, the composition of the core layer comprises about 1.0 wt % to about 1.75 wt % oxidizers. In still a more particular aspect, the composition of the core layer comprises approximately 1.32 wt % oxidizers.

In one or more embodiments, the composition of the core layer further comprises one or more cross-linking agents. The cross-linking agent may comprise any agent or compound for cross-linking EVA such that the final core layer comprises an improved heat resistance, flame resistance, solvent resistance, and resistance to deformation. In a particular embodiment, the cross-linking agent comprises triaryl-isocyanurate (TAIC). According to one aspect, the amount of cross-linking agents in the composition of the core layer comprises about 0 wt % to about 1 wt % cross-linking agents. In still another aspect, the composition of the core layer comprises about 0.05 wt % to about 0.5 wt % cross-linking agents. In still a more particular aspect, the composition of the core layer comprises about 0.06 wt % to about 0.25 wt % cross-linking agents. In still a more particular aspect, the composition of the core layer comprises approximately 0.12 wt % cross-linking agents.

In one or more embodiments, the composition of the core layer further comprises one or more curing agents. The one or more curing agents may comprise any agent or compound that assists in formation of an EVA foam with more uniform bubbles. The one or more curing agents may also improve the heat resistance and weather resistance of the core layer. In a particular embodiment, the one or more curing agents comprise dicumyl peroxide (DCP). According to one aspect, the amount of curing agents in the composition of the core layer comprises about 0 wt % to about 3 wt % curing agents. In still another aspect, the composition of the core layer comprises about 0.4 wt % to about 2 wt % curing agents. In still a more particular aspect, the composition of the core layer comprises about 0.6 wt % to about 1.0 wt % curing agents. In still a more particular aspect, the composition of the core layer comprises approximately 0.82 wt % curing agents.

In one or more embodiments, the composition of the core layer further comprises one or more coloring agents. The one or more coloring agents may comprise a masterbatch colorant or any other colorant known in the art that at least partially controls the color of the final core layer. In a particular embodiment, the masterbatch colorant comprises a solid colorant. According to one aspect, the amount of coloring agents in the composition of the core layer comprises about 0 wt % to about 2 wt % coloring agents. In still another aspect, the composition of the core layer comprises about 0.25 wt % to about 2 wt % coloring agents. In still a more particular aspect, the composition of the core layer comprises about 0.4 wt % to about 0.7 wt % coloring agents. In still a more particular aspect, the composition of the core layer comprises approximately 0.54 wt % coloring agents. A color paste may be utilized to dye any fabrics used in the steering wheel cover.

In one or more embodiments, the composition of the core layer further comprises one or more foaming agents. In a particular embodiment, the foaming agent comprises azodicarbonamide (ADCA). According to one aspect, the amount of foaming agents in the composition of the core layer comprises about 0 wt % to about 0.1 wt % foaming agents. In still another aspect, the composition of the core layer comprises about 0.005 wt % to about 0.05 wt % foaming agents. In still a more particular aspect, the composition of the core layer comprises about 0.007 wt % to about 0.015 wt % foaming agents. In still a more particular aspect, the composition of the core layer comprises approximately 0.01 wt % foaming agents.

Also contemplated, as part of this disclosure, is a method of manufacturing a steering wheel cover. Various embodiments of the core layer are manufactured through an injection molding process, which is highly advantageous to the extrusion process of conventional steering wheel covers. Because the core layer is formed through injection molding, the ribs previously described herein may be formed during the actual molding process. Furthermore, these ribs may be formed to advantageous sizes and configurations when compared to anything known in the prior art. For example, in one or more embodiments, each of the plurality of ribs are tapered, as described above. This tapering feature of the ribs is not possible in conventional steering wheel covers formed through an extrusion process.

It will be understood that implementations are not limited to the specific components disclosed herein, as virtually any components consistent with the intended operation of a method and/or system implementation for steering wheel cover may be utilized. Accordingly, for example, although particular steering wheel covers may be disclosed, such components may comprise any shape, size, style, type, model, version, class, grade, measurement, concentration, material, weight, quantity, and/or the like consistent with the intended operation of a method and/or system implementation for a steering wheel cover may be used.

In places where the description above refers to particular implementations of steering wheel covers, it should be readily apparent that a number of modifications may be made without departing from the spirit thereof and that these implementations may be applied to other steering wheel covers. The accompanying claims are intended to cover such modifications as would fall within the true spirit and scope of the disclosure set forth in this document. The presently disclosed implementations are, therefore, to be considered in all respects as illustrative and not restrictive, the scope of the disclosure being indicated by the appended claims rather than the foregoing description. All changes that come within the meaning of and range of equivalency of the claims are intended to be embraced therein.

1. A steering wheel cover consisting essentially of a core layer, the core layer comprising an inner surface molded to form and self-maintain an annular channel sized to receive an automobile steering wheel therein, an outer surface, and two opposing terminating edges.

2. The steering wheel cover of claim 1, wherein the core layer comprises a first foamed material.

3. The steering wheel cover of claim 2, wherein the first foamed material comprises ethyl-vinyl acetate.

4. The steering wheel cover of claim 2, wherein the core layer further comprises a plurality of ribs protruding from the inner surface of the annular channel.

5. The steering wheel cover of claim 2, wherein the core layer further comprises one or more protrusion extending outward from the outer surface of core layer.

6. The steering wheel cover of claim 2, wherein the one or more protrusions comprise a second foamed material that is firmer than the first foamed material.

7. The steering wheel cover of claim 6, wherein the first foamed material is molded to the second foamed material.

8. The steering wheel cover of claim 1, further comprising a plurality of holes extending through the core layer.

9. A steering wheel cover comprising a core layer, the core layer comprising an inner surface molded to form and self-maintain an annular channel sized to receive an automobile steering wheel therein, an outer surface, and two opposing terminating edges, wherein the steering wheel cover is devoid of an outer cover layer coupled to the core layer and stitching proximate the two terminating edges.

10. The steering wheel cover of claim 9, wherein the core layer comprises a first foamed material.

11. The steering wheel cover of claim 10, further comprising one or more protrusions extending from the outer surface of the core layer.

12. The steering wheel cover of claim 11, wherein the protrusions comprise a second foamed material molded to the first foamed material.

13. The steering wheel cover of claim 12, wherein the first and second foamed materials comprise different densities.

14. The steering wheel cover of claim 9, further comprising a plurality of ribs protruding from the inner surface of the annular channel.

15. The steering wheel cover of claim 9, further comprising a plurality of holes extending through the core layer.

16. The steering wheel cover of claim 9, wherein the first foamed material comprises primarily ethyl-vinyl acetate.

17. A method of manufacturing a steering wheel cover, the method comprising:
injecting a first foamed material into a first cavity of a mold assembly to form a core layer of a steering wheel cover;
curing the core layer;
removing the core layer from the mold assembly; and
cooling the core layer such that the core layer comprises a self-maintaining annular channel sized to receive an automobile steering wheel therein.

18. The method of claim 17, further comprising injecting a second foamed material into a one or more second cavities of the mold assembly adjacent the first cavity to form one or more protrusions extending from an outer surface of the core layer, wherein curing the core layer comprises curing and bonding together the core layer and the one or more protrusions.

19. The method of claim 18, wherein the first foamed material and the second foamed material comprise different densities.

20. The method of claim 17, further comprising forming one or more holes in the core layer during molding.
